(19) United States
(12) Patent Application Publication
(10) Pub. No.: US 2024/0101830 A1
(43) Pub. Date: Mar. 28, 2024

(54) METALLIC PIGMENT PREPARATION

(71) Applicant: Sun Chemical Corporation, Parsippany, NJ (US)

(72) Inventor: Blayne PHILLIPS, Cincinnati, OH (US)

(21) Appl. No.: 18/508,555

(22) Filed: Nov. 14, 2023

Related U.S. Application Data
(63) Continuation of application No. PCT/US22/31246, filed on May 27, 2022.
(60) Provisional application No. 63/193,634, filed on May 27, 2021.

(51) Int. Cl. C09C 1/62; C09C 1/64; C09D 5/10; C09D 17/00

(52) U.S. Cl. CPC C09C 1/62; C09C 1/644; C09D 5/103; C09D 17/006

(57) ABSTRACT

A metallic pigment preparation that is composed of a metallic pigment, and a passivating agent and a neutralizing agent. The preparation can be provided in a non-dusting form, particularly in the shape of the pellet. The preparation can be easily stirred into aqueous or solvent-based liquid formulations. The preparation can also be used in natural rubber or synthetic latex.

### BACKGROUND

Metal powders and pigments, for example, aluminum, exothermically react in the presence of water to release hydrogen gas. The formation of gas is detrimental as it can cause defects in coatings and other articles containing metallic pigments. Further, the handling of metallic pigments and powders can be dangerous due to the risk of forming explosive dust clouds. The present development solves these problems by passivating the aluminum to aqueous attack and by providing it in a form that prevents dust formation.

Metallic effect pigments are platelet-shaped materials used to produce a metallic appearance with a characteristic light-to-dark “flip-flop” effect when viewed from different angles. It is desirable to provide this effect on packaged goods, automobiles, and plastic articles. Applications that have a high-pH or are strongly oxidative are usually not suitable metallic pigments, due to their inherent reactivity.

The most common metal used for metallic effect pigments is aluminum, which has a bright silver color. Aluminum pigments are typically produced via ball milling metallic grit in the presence of a lubricant to a flat, platelet shape.

Due to the reactivity of aluminum, formulation into water-based application may cause corrosion, leading to hydrogen gas generation and discoloration. Various strategies are used to improve the stability of metallic pigments in waterborne environments, including chemical passivation of the pigment surface by silicates, phosphates, phosphites, molybdates, chromates, or vanadates. While these strategies are effective, the pigments remain unstable in applications with extreme acidic or basic pH, such as latexes. In addition, aluminum pigments are typically provided as a paste with solvents that are immiscible or incompatible with latex. Removing the solvent to produce a dried pigment powder is one solution, however dried metallic pigments may produce a significant amount of potentially explosive dust.

The current development solves these issues by providing a non-dusting aluminum pigment preparation for use in a wide range of applications. The non-dusting aluminum pigment preparation is formulated to allow for rapid incorporation into aqueous systems with a high pH such as latex paint systems or latex dispersions for rubber articles. The pigments of the current development can additionally be used in any type of solvent, allowing for a colorant that works in solvent and water-based coatings formulations over a wide range of applications and loadings.

The metallic pigment preparation may be used in high pH systems or dispersions allowing for the production of latex coatings and rubber articles with a metallic appearance. The metallic pigment preparation improves the safety and durability when formulating with high pH systems. The safety is improved by reducing the likelihood of gas generation. Safety is also improved by providing a pellet that is more resistant to crumbling and forming dust. Durability of the pigment in the preparation is improved thereby increasing the life span of aluminum-latex dispersions used for the manufacture of rubber articles. The metallic pigment preparation also resists aggregation improving shelf-life and appearance.

### BRIEF SUMMARY

This development relates to a metallic pigment preparation comprising a metallic pigment, and a passivating agent, wherein the passivating agent is a dimer and/or trimers fatty acid with >1 carboxylic acid groups. The term ‘fatty acid(s)’ is defined by the metes and bounds of this application.

The passivating agent may be in the range of 5%-23% with respect to the total weight of the metallic pigment preparation and the unsaturated fatty acids comprise C3-C20 unsaturated fatty acids. The unsaturated fatty acids are selected from the group consisting of acrylic acid, methacrylic acid, oleic acid, elaidic acid, gonoidic acid, erucic acid, palmitoleic acid, vaccenic acid, linoleic acid linolelaidic acid, γ-linolenic acid, α-linolenic acid, stearidonic acid, and mixtures thereof.

In general, the passivating agent is selected from structures 1-4 and combinations thereof.

The passivating agents may be represented by dimer or trimer fatty acids with >1 carboxylic acid groups having a basic structure of (1):

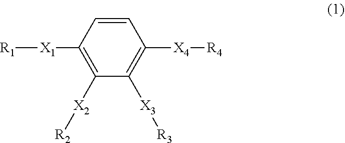

where X₁, X₂, X₃, and X₄ are independently an aliphatic chain of 0-20 sp³ or sp² hybridized carbon atoms, and R₁, R₂, R₃, and R₄ are independently an end group selected from H, COOH, COO″, OH, CH₃, tertiary butyl, isopropyl groups. In this scenario, the passivating agent may be selected from the group consisting of phthalic acid, terepthalic acid, isopthalic acid, 1,4-phenylenediacrylic acid, benzene-1,3,5-triacetic acid, 3-(4-carboxyphenyl)propionic acid and 1,4-phenylenedipropionic acid. 1,3-phenylenediacetic acid, p-phenylenediacetic acid, and aromatic isomers of C36 dimers.

The passivating agents may also be represented by dimer or trimer fatty acids with >1 carboxylic acid groups have a basic structure (2):

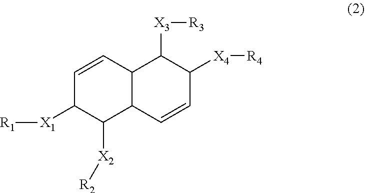

where X₁, X₂, X₃, and X₄ are independently an aliphatic chain of 0-20 sp3 or sp2 hybridized carbon atoms, and R₁, R₂, R₃, and R₄ are independently be an end group selected from H, COOH, COO—, OH, CH₃, tertiary butyl, isopropyl groups.

The passivating agents may also be represented by dimer or trimer fatty acids with >1 carboxylic acid groups have a basic structure (3):

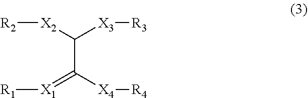

where X₁, X₂, X₃, and X₄ are independently an aliphatic chain of 0-20 sp3 or sp2 hybridized carbon atoms, and R₁, R₂, R₃, and R₄ may independently be an end group from one of the following: H, COOH, COO—, OH, CH₃, tertiary butyl, isopropyl groups. In one embodiment, at least two of the R groups are COOH or COO— groups. In this scenario, the passivating agents represented by dimer or trimer fatty acids with >1 carboxylic acid groups of the basic structure (3) include non-cyclic isomers of C36 dimers.

The passivating agents may also be dimer or trimer fatty acids with >1 carboxylic acid groups and have a basic structure (4):

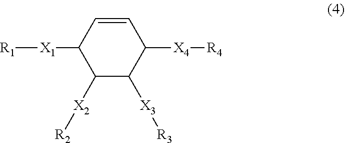

where X₁, X₂, X₃, and X₄ are independently an aliphatic chain of 0-20 sp3 or sp2 hybridized carbon atoms, and R₁, R₂, R₃, and R₄ may independently be an end group from one of the following: H, COOH, COO—, OH, CH₃, tertiary butyl, isopropyl groups. The passivating agents represented by structure 4 may be cis-4-Cyclohexene-1,2-dicarboxylic acid, 5 (or 6)-carboxy-4-hexylcyclohex-2-ene-loctanoic acid, and cyclic isomers of C36 dimers.

The metallic pigment contained in the metallic pigment preparation may be present from 60-95% with respect to the total weight of the preparation, and from 77-95% with respect to the total weight of the preparation, and from 85-99% of a metal and with 1-15% of a milling aid, with respect to the total weight of the preparation.

The metallic pigment preparation may be coated with one or more metal oxides selected from silicon oxide, titanium dioxide, zinc oxide, zirconium dioxide, tin oxide, cerium dioxide, vanadium (IV) oxide, manganese oxide, lead oxide, chromium oxide, iron oxide, aluminum oxide, tungsten oxide, and mixtures and alloys.

The metallic pigment preparation may further comprise additives selected from neutralizing agents, pH adjusters, dispersing additives, anti-foam additives, de-foaming additives, and adhesion promoters, wherein pH adjusters are amines.

The metallic pigment preparation may be used in paints, inks, coatings or latex as well as plastic or rubber compositions.

### DETAILED DESCRIPTION

This development relates to a metallic pigment preparation that is comprised of a metallic pigment, a passivating agent, and a neutralizing agent. The preparation can be provided in a non-dusting form, for instance, in the shape of the pellet. The preparation may be stirred into aqueous or non-aqueous, solvent-based liquid formulations. The preparation may also be used in natural rubber or synthetic latex.

The metal effect pigment preparations comprise a novel passivation technology. Typical passivation strategies fall into two categories: (1) use of a physical barrier that blocks the aluminum surface from environment, such as SiO₂; or (2) use of a chemical passivation strategy such as a molybdate, chromate, vanadate, or phosphate ester. In contrast, this current development uses a dimer or trimer fatty acid to obtain passivation of aluminum pigments. The term ‘fatty acid(s)’ is defined by the metes and bounds of this application. This development represents a new category of pigment passivation agents. While the anticorrosion potential of dimer acids has been observed for large metal parts, the use of dimer acids as anticorrosion agents has not been reported to be used for metallic pigments except as promoters for organic pigment adhesion, or, unless used in combination with long chain, aliphatic amines.

Additionally, the effect pigment preparations may be provided in a pelletized form, and do not need to be supplied as a paste. Moreover, the preparation has a simpler formulation than other formulations currently described. Finally, passivation strategy enables the use of aluminum pigments in applications comprising latex.

The metallic pigment preparation is comprised of metallic pigment, a passivating agent and optionally an additive(s). The metallic pigment preparations may be provided in a solid form that does not produce large quantities of dust. The metallic pigment could be provided in a solid form, such as a pellet or prill, in order to minimize dust and eliminate solvents.

In one embodiment the metallic pigment preparation contains a metallic pigment, a passivating agent, and an optional additive. In the case where the metallic pigment is used in metallic pigment preparation, it may be present at a range of 60-95% with respect to the total weight of the preparation.

In another embodiment the metallic pigment preparation contains a metallic pigment, a passivating agent, and an optional additive. In the case where the metallic pigment is used in metallic pigment preparation, then it may be present at a range of 77-95% with respect to the total weight of the preparation.

In one embodiment, the metallic pigment is comprised of a metal and a milling aid. In one embodiment, the metallic pigment may contain between 85-99% of a metal and 1-15% of a milling aid. The metal comprising the metallic pigment in the metal pigment preparation may be one or more from the following list of aluminum, bismuth, copper, copper-zinc alloys, copper-tin alloys, stainless steel, carbon steel, iron, silver, zinc, nickel, titanium, chromium, manganese, vanadium, magnesium, zinc-magnesium alloys, and alloys and mixtures thereof.

In one embodiment, the milling aid comprising the metallic pigment may be a saturated or unsaturated fatty acid with between 8-22 carbon atoms. By saturated it is meant that there are no double bonds between the C atoms, by unsaturated, it is meant that there is at least one double bond between two adjacent carbon atoms.

In the case where a fatty acid is used, the fatty acid may include but is not limited to oleic acid, stearic acid, caprylic acid, capric acid, lauric acid, myristic acid, palmitic acid, arachidic acid, behenic acid, lignoceric acid, cerotic acid, myristoleic acid, palmitoleic acid, spienic acid, oleic acid, elaidic acid, vaccenic acid, linoleic acid, lineolaidic acid, and mixtures thereof.

The metallic pigment used in the metallic pigment preparation may be platelet and/or flake shaped. By platelet or flake shaped, it is meant that one dimension of the metallic pigment particle is significantly smaller than the other dimensions. In the case where the metallic pigment is a flake shaped, then the pigment may have a major axis or diameter in the range of 1 μm to 500 μm, 2 μm to 100 μm and 5 μm to 75 μm. The metallic pigment may have a minor axis or thickness in the range of 5 nm to 5 μm, 5 nm to 3 μm and 10 nm to 2 μm.

The shape of the metallic pigment flake may be described as cornflake, silver dollar, vacuum metalized flake (VMP), or other term used to those skilled in the art.

In one embodiment, the metallic pigment used in the metallic pigment preparation of the development may be optionally coated with one or more metal oxides without limiting the scope. If a metal oxide is used to coat the metallic pigment, then the metal oxide may include, but is not limited to silicon oxide, titanium dioxide, zinc oxide, zirconium dioxide, tin oxide, cerium dioxide, vanadium (IV) oxide, manganese oxide, lead oxide, chromium oxide, iron oxide, aluminum oxide, tungsten oxide, and mixtures and alloys thereof. Other oxides may also be used without limiting the scope of the development. The coating may also comprise a hydrated oxide of any one of the aforementioned oxides. The coating may also be a doped oxide of any one of the aforementioned. The thickness of the metal oxide layers may be variable but may also allow for partial transparency. In general, the thickness of the metal oxide layers is in the range of about 10 nm to 350 nm.

In one embodiment, the metallic pigment preparation contains passivating agent. In the case where passivating agent is used, it may be added in the range of 5%-23%. with respect to the total weight of the metallic pigment preparation. The passivating agents used in the current development may be described as dimer or trimer fatty acids. Fatty acid dimers and trimers may be produced by reacting 2 or more unsaturated fatty acids to form a structure comprised of a reaction product of the starting fatty acids. Suitable unsaturated fatty acids that may be used to make the fatty acid dimer include C3-C20 unsaturated fatty acids. The fatty acids may be the same, or they may be different. Examples of fatty acids used to make the fatty acid dimer or trimer include, but are not limited to, acrylic acid, methacrylic acid, oleic acid, elaidic acid, gonoidic acid, erucic acid, palmitoleic acid, vaccenic acid, linoleic acid linolelaidic acid, γ-linolenic acid, α-linolenic acid, stearidonic acid, and mixtures thereof.

Dimer and trimer fatty acids typically may be prepared by condensing unsaturated monofunctional carboxylic acids such as oleic, linoleic, soya or tall oil acid through their olefinically unsaturated groups, in the presence of catalysts such as acidic clays. The distribution of the various structures in dimer acids (nominally C36 dibasic acids) depends upon the unsaturated acid used in their manufacture. Typically, oleic acid provides a dimer acid containing about 38% acyclics, about 56% mono- and bicyclics, and about 6% aromatics. Soya acid provides a dimer acid containing about 24% acyclics, about 58% mono- and bicyclics and about 18% aromatics. Tall oil acid gives a dimer acid containing about 13% acyclics, about 75% mono- and bicyclics and about 12% aromatics.

Dimer and trimer fatty acids are commercially available from a variety of vendors, including Ingevity (as EnvaDym® 175, 295, 595, Diacid 1550) and Croda International Plc (as Pripol™ 1004 and 1009). For further information concerning these acids, see (1) Leonard, Edward C., “The Dimer Acids,” Humko Sheffield Chemical, Memphis, Tenn., 1975, pp. 1, 4 and 5, and (2) the Kirk-Othmer Encyclopedia of Chemical Technology, John Wiley & Sons, 3rd ed., Vol. 7, 1979, pp. 768-770. Different grades exist for the dimer and trimer acids. Some have been hydrogenated to remove olefinic double bonds and/or distilled for purification.

The dimer and trimer fatty acids obtained in this way may be described as acyclic, cyclic, aromatic or polycyclic. These dimer and trimer fatty acids are commercially available as mixture of isomers and monomers. Trimer fatty acids have similar structures to dimer fatty acids except that they contain an additional carboxyl group, an additional hydrocarbon tail group, and a greater degree of polycyclic isomerism. Purified dimer and trimer fatty acids are also commercially available.

In one embodiment, the passivating agents are dimer or trimer fatty acids with >1 carboxylic acid groups and are given by the basic structure (1):

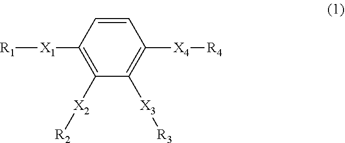

Where X₁, X₂, X₃, and X₄ is independently an aliphatic chain of 0-20 sp³ or sp² hybridized carbon atoms, and R₁, R₂, R₃, and R₄ may independently be an end group from one of the following: H, COOH, COO″, OH, CH₃, tertiary butyl, isopropyl. In one embodiment, at least two of the R groups are COOH or COO″ groups. Examples of the type of passivating agents represented by Equation 1 include but are not limited to phthalic acid, terepthalic acid, isopthalic acid, 1,4-phenylenediacrylic acid, benzene-1,3,5-triacetic acid, 3-(4-carboxyphenyl)propionic acid and 1,4-phenylenedipropionic acid. 1,3-phenylenediacetic acid, p-phenylenediacetic acid, and aromatic isomers of C36 dimers.

In further embodiments, the passivating agents are dimer or trimer fatty acids with >1 carboxylic acid groups and are given by the basic structure (2):

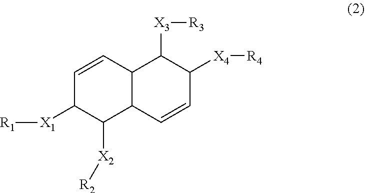

Where X₁, X₂, X₃, and X₄ is independently an aliphatic chain of 0-20 sp3 or sp2 hybridized carbon atoms, and R₁, R₂, R₃, and R₄ may independently be an end group from one of the following: H, COOH, COO—, OH, CH₃, tertiary butyl, isopropyl. In one embodiment, at least two of the R groups are COOH or COO— groups. Examples of the type of passivating agents represented by Equation 2 include but are not limited to bicyclic isomers of C36 dimers.

In further embodiments, the passivating agents are dimer or trimer fatty acids with >1 carboxylic acid groups and are given by the basic structure (3):

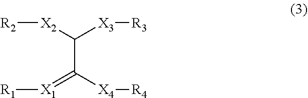

Where X₁, X₂, X₃, and X₄ is independently an aliphatic chain of 0-20 sp3 or sp2 hybridized carbon atoms, and R₁, R₂, R₃, and R₄ may independently be an end group from one of the following: H, COOH, COO—, OH, CH₃, tertiary butyl, isopropyl. In one embodiment, at least two of the R groups are COOH or COO— groups. Examples of the type of passivating agents represented by Equation 3 include but are not limited to non-cyclic isomers of C36 dimers.

In further embodiments, the passivating agents are dimer or trimer fatty acids with >1 carboxylic acid groups and are given by the basic structure (4):

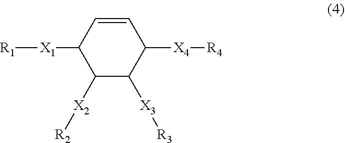

Where X₁, X₂, X₃, and X₄ is independently an aliphatic chain of 0-20 sp3 or sp2 hybridized carbon atoms, and R₁, R₂, R₃, and R₄ may independently be an end group from one of the following: H, COOH, COO—, OH, CH₃, tertiary butyl, isopropyl. In one embodiment, at least two of the R groups are COOH or COO— groups. Examples of the type of passivating agents represented by Equation 4 include but are not limited to cis-4-Cyclohexene-1,2-dicarboxylic acid, 5 (or 6)-carboxy-4-hexylcyclohex-2-ene-1octanoic acid, and cyclic isomers of C36 dimers.

The passivating agent may be a combination of any of the compounds given structures 1-4.

In a further embodiment, the effect pigment preparation may optionally contain additional additives. These additives include but are not limited to pH adjusters, dispersing additives, anti-foam additives, de-foaming additives, and adhesion promoters. pH adjusters such as ammonia, amines, metal carbonate salts, and metal hydroxide salts. The type and class of dispersing additive is not important, and any dispersing additive compatible with the system for the application and known to those skilled in the art may be used. The dispersing additive may be a surfactant or a polymeric dispersant. The dispersing additives may be any commercially available dispersant known to those skilled in the art.

The metallic pigment preparation of the development may be provided at solids >95%. The metallic pigment preparation of the development may be provided in a dry, non-dusting form. The metallic pigment preparation may be provided in number of shapes including but not limited to pellets, bricks, granules, prills, briquets, and/or tablets.

The metallic pigment preparation can be incorporated, for example, into a number of different applications including waterborne and solvent borne latex, printing inks, and coatings.

In some embodiments, the metallic pigment preparation of the development may be used in latex dispersions to provide a metallic effect to articles made of latex rubber. The latex may be natural or synthetic or a combination thereof. Natural latex dispersion is a dispersion of poly-cis-isoprene obtained from cultivation of Hevea brasillensis (rubber tree) and may have various additives to modify its behavior. Synthetic latex dispersions are derived from petroleum-based monomers, these include but are not limited to nitrile rubber, polyisoprene, chloroprene, butyl rubber, with additional additives to modify the behavior. In both synthetic and natural rubber dispersions, the additional additives may include, but are not limited to, one or more pH adjusters, vulcanizing agents, vulcanizing accelerants, chelators, dispersants, rheology modifiers, organic pigments, fillers, and mixtures thereof. Typical articles made of latex rubber include, but are not limited to, gloves, balloons, clothing, footwear, mattresses, swim caps, prophylactics, paints, and other items known to those skilled in the art.

When added to a latex dispersion, the content of the metallic pigment preparation of the development in the latex dispersion may be in the range of 0.1% to 30% by weight with respect to the weight of the latex dispersion. According to the present development, dispersants, pH adjusters, water, organic solvents, corrosion inhibitors, rheology modifiers, thickeners, antifoams, biocides, preservatives and defoamers as well as other additives known in the art may be included in the latex composition. The content of the metallic pigment of the development in the latex dispersion may be in the range of 1% to 20% with respect to the weight of the latex dispersion. Rubber articles may be obtained by any number of dipping, casting or molding methods known to those familiar with the art. The content of metallic pigment in a rubber article prepared in this manner may be in the range of 0.2-20%. Rubber articles produced in this way have a metallic appearance with the characteristic light-to-dark flip flop appearance.

The latex may contain additional coloring agents including, another colored pigment, effect pigment, extender or dye. Illustrative examples of the color pigment include phthalocyanine, iron oxide, quinacridone, perylene, isoindoline, azo lake, chrome yellow, carbon black, and titanium dioxide. Illustrative examples of the effect pigment include flake-form pigments of pearlescent mica, aluminum, brass, copper, silica, aluminum oxide and the like.

The metallic pigment preparation behaves like a universal pigment and can be readily stirred into all types of liquid coating applications including, automotive coatings, interior architectural coatings, exterior architectural coatings, gravure inks, flexographic inks, paste inks, energy curing (UV or EB) inks, etc. Additionally, the metallic pigment preparation may be used in combination with other effect pigments or organic pigments in all ratios without limiting the scope of the development.

The content of the metallic pigment in the coating or ink composition may be set in the range of 0.1% to 50% by weight with respect to the other components of the coating system. The content of the effect pigment preparation may be set in the range of 1% to 40% by weight with respect to the other components of the coating system.

The coating or ink composition according to the present development is obtained by blending the metallic pigment preparation of the current technology with a coating resin. Polyester, polyurethane, polyvinyl, cellulose, polyamide, nitrocellulose, acrylic, alkyd, fluorinated resins or the like can be used as the coating resin.

For the coating composition according to the present development, another organic pigment, effect pigment, extender or dye can be employed in addition to the effect pigment preparation of the present technology. If an organic pigment is used then the types of organic pigments that can be used in the current development are all types of azo pigments, polycylic pigments, anthraquinone pigments including monoazo pigments, disazo pigments, disazo condensation pigments, naphthol pigments, benzimidazolone pigments, isoindolinone pigments, isoindoline pigments, metal complex pigments, quinacridone pigments, perylene pigments, carbon black pigments, phthalocyanine pigments, perinone pigments, diketopyrrolo-pyrrole pigments, thioindigo pigments, anthropyrimidine pigments, flavanthrone pigments, anthanthrone pigments, dioxazine pigments, triarylcarbonium pigments, quinophthalone pigments, or any combination thereof. Illustrative examples of the effect pigment include flake-form pigments of TiO₂-coated mica, TiO₂-coated synthetic mica, TiO₂-coated glass flake, TiO₂-coated platy alumina, iron oxide-coated mica, iron oxide-coated synthetic mica, iron oxide-coated glass flake, iron oxide-coated alumina, aluminum, silica-coated aluminum, brass, copper, natural mica, synthetic mica, borosilicate glass flake, silica, aluminum oxide and the like. The list of illustrative effect pigments additionally includes pearlescent pigments that are coated with one or more layers of metal oxides, including tin oxide, titanium dioxide, iron (II) oxide, iron (III) oxide, iron hydroxide, magnetite, maghemite, chromium oxide, cerium oxide, zirconium oxide and others without limiting the scope of the development.

According to the present development, a crosslinker, water, an organic solvent, an interfacial active agent, a hardener, an ultraviolet absorber, a thickener, a corrosion inhibitor as well as other additives known in the art can be included in the coating composition.

If the coating according to the present development is an ink, then the metallic pigment preparation of the current technology may be used in any ink including solvent borne, waterborne and energy curable packaging inks. If the pigments of the current development are used in a packaging ink, then they may be used to color both the interior and the exterior of a package or other container. The metallic pigment preparation-containing ink may be flexographic, screen, paste, sheetfed, energy cured, gravure or ink jet.

If the coating according to the present development is a paint, then the metallic pigment preparation of the current development may be used in any type of paint, including refinish and OEM automotive paints, interior and exterior architectural paints, latex paint, and industrial paints.

The present development has been described in detail, including the preferred embodiments thereof. However, it will be appreciated that those skilled in the art, upon consideration of the present disclosure, may make modifications and/or improvements on this development that fall within the scope and spirit of the development.

### EXAMPLES

The development is further described by the following non-limiting examples which further illustrate the development, and are not intended, nor should they be interpreted to, limit the scope of the development.

### Inventive Examples 1 & 2

150 g of a metallic pigment paste is blended for 30 minutes in a planetary mixer with a treatment mixture. The treatment mixture includes passivating agent, 10 g of water and additional additives. The resulting paste is pelletized and dried at 60-80° C. for 8-12 hours. The obtained pellets are dry and non-dusting. A description of the pigments used in Examples 1-2 is given in Table 1. A description of the treatment mixture used in Examples 1-2 is given in Table 2.

TABLE 1
Description of metallic pigments used in the Examples

| Pigment name | Manufacturer | Description |
|---|---|---|
| BL2051 | Sun Chemical | Cornflake type aluminum paste |
| Aluminum Flake | Sun Chemical | Silver dollar flake type aluminum |
| d50: 11-20 [symbol] m | | paste |

TABLE 2
Amount and type of passivating agent and additional additives used to
produce metallic pigment preparation

| | | | | Treatment | | pH | | |
|---|---|---|---|---|---|---|---|---|
| | Metallic | | | (passivating | | Adjuster | | |
| Ex. # | Pigment | Passivating agent | CODE | agent) (g) | pH Additive | (g) | Dispersant | Dispersant |
| Ex. 1 | BL2051 | 5(or 6)-carboxy- | 4263-8-1 | 10.5 | 2-amino-2- | 4.3 | Tween 40 | 5.25 |
| | | 4-hexylcyclohex- | | | methyl- | | | |
| | | 2-ene-1-octanoic | | | propan-1-ol | | | |
| | | acid | | | | | | |
| Ex. 2 | BL64068 | 5(or 6)-carboxy- | 4263-43 | 10 | 2-amino-2- | 2.7 | — | — |
| | | 4-hexylcyclohex- | | | methyl- | | | |
| | | 2-ene-1-octanoic | | | propan-1-ol | | | |
| | | acid | | | | | | |

### Comparative Example 5—Untreated Aluminum Pigment Commercially Available as BL 6282 IP (Sun Chemical)

### Comparative Example 6—Treated Aluminum Pigment Preparation BL Compal 4242 WS (Sun Chemical)

### Example: Stability Test

Approximately 20 g of the example effect pigment preparation under test was combined with 50 mL butyl glycol and 50 mL deionized water in a 300 mL Erlenmeyer flask and mixed for 5 minutes. This apparatus was placed in a water bath at 40° C. and sealed. After a 30-minute incubation, the flask is connected to a sealed gas burette that was filled with deionized water, the hydrogen gas evolving from the sample was allowed to enter the burette and displace the water. The test continued for 30 days and the amount of gas generated over this period was recorded. Table 3 shows the number of days until failure (>100 mL gas evolved) and the volume of gas evolved.

TABLE 3
Stability test results for metallic pigments and metallic
pigment preparations in water and butyl glycol mixture.

| | Gas Test (days to failure) | Volume at end point |
|---|---|---|
| Example | (30 max) | (mL) |
| Ex. 1 | 30 | 31 |
| Ex. 2 | 30 | 43 |
| Comp. Ex 5 | 1 | >100 |
| Comp. Ex 6 | 30 | 34.5 |

The metallic pigment preparations show good stability in an aqueous system and are suitable for waterborne formulation.

### Example: Latex Longevity Test

5 g of metallic preparation is added to 150 g of natural rubber latex (Killian Latex, Akron, OH) and allowed to stir in a manner that does not generate turbulence. The number of days the latex dispersion remains fluid by visual assessment is determined for a maximum of 21 days. Viscous gelling and solidification as noted visually are considered failures. The results are summarized in Table 4.

TABLE 4
Results of latex longevity test.

| Sample | Days until failure |
|---|---|
| Example 2 | 21 |
| Comp. Ex. 6 | 14 |
| Comp. Ex 5 | 0 |

The data in Table 4 shows the improved stability (longevity) of the inventive pigment preparations.

### Use Examples

### Example 7 (Aluminum Pigmented Latex Articles)

20 g of the preparation prepared in Example 1 is mixed with 40 g of deionized water. 15 g of this mixture is added to 150 g of compounded natural rubber latex (Killian Latex, Akron, OH). The pH is then adjusted to 8-12. The mixture is stirred in a non-turbulent way to maintain homogeneity of the mixture. Rubber articles are prepared via dipping onto forms and film casting. These articles produce the characteristic dark to light flip flop effect and are free of pinholing defects that are characteristic of aluminum reactions in latex. This shows that Example 1 preparation is suitable for manufacturing articles via dip coating or casting at a manufacturing scale to produce defect free rubber goods with a metallic flip-flop effect.

### Example 8 (Metallic Pigment Preparation in Waterborne Ink)

10 g of the metallic pigment preparation prepared in Example 1-2 is mixed with 10 g of deionized water. This mixture is added to 40 g of a waterborne ink resin Joncryl 1655 and mixed in a DAC High Speed Mixer for 2 min @ 2,000 RPM. The prepared ink shows the characteristic flip-flop effect of metallic inks is seen when printed or drawn as a film. The ink is agglomerate free. This shows that waterborne inks made with the inventive pigment preparation is suitable for use at press for printing packaging and labels with a characteristic metallic flip-flop effect.

### Example 9 (Aluminum Pigmented Latex Paint)

1 g of Example 2 and 1 g of deionized water is added to 9 g of a water based latex paint system and mixed in a DAC High Speed Mixer for 2 min @ 2,000 RPM. The prepared paint showed the characteristic flip-flop effect of metallic paints. The paint was agglomerate free. This shows that a latex paint made with the inventive pigment preparation is suitable for providing surfaces with a metallic flip-flop effect.

1. A metallic pigment preparation comprising a metallic pigment, and a passivating agent, wherein the passivating agent is a dimer or trimer fatty acid with >1 carboxylic acid groups.

2. The metallic pigment preparation of claim 1, wherein the passivating agent is in the range of 5%-23% with respect to the total weight of the metallic pigment preparation.

3. The metallic pigment preparation of claim 1, wherein the unsaturated fatty acids comprise C3-C20 unsaturated fatty acids.

4. The metallic pigment preparation of claim 3, wherein the unsaturated fatty acids are selected from the group consisting of acrylic acid, methacrylic acid, oleic acid, elaidic acid, gonoidic acid, erucic acid, palmitoleic acid, vaccenic acid, linoleic acid linolelaidic acid, γ-linolenic acid, α-linolenic acid, stearidonic acid, and mixtures thereof.

5. The metallic pigment preparation of claim 1, wherein the passivating agents represented by dimer or trimer fatty acids with >1 carboxylic acid groups have a basic structure of (1): 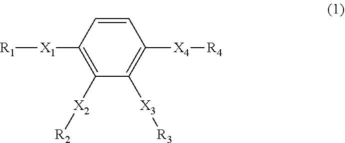
where X₁, X₂, X₃, and X₄ are independently an aliphatic chain of 0-20 sp³ or sp² hybridized carbon atoms, and R₁, R₂, R₃, and R₄ are independently an end group selected from H, COOH, COO⁻, OH, CH₃, tertiary butyl, isopropyl groups.

6. The metallic pigment preparation of claim 5, wherein the passivating agent is selected from the group consisting of phthalic acid, terepthalic acid, isopthalic acid, 1,4-phenylenediacrylic acid, benzene-1,3,5-triacetic acid, 3-(4-carboxyphenyl)propionic acid and 1,4-phenylenedipropionic acid. 1,3-phenylenediacetic acid, p-phenylenediacetic acid, and aromatic isomers of C36 dimers.

7. The metallic pigment preparation of claim 1, wherein the passivating agents represented by dimer or trimer fatty acids with >1 carboxylic acid groups have a basic structure (2): 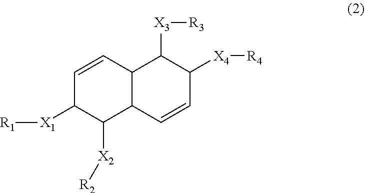
where X₁, X₂, X₃, and X₄ are independently an aliphatic chain of 0-20 sp3 or sp2 hybridized carbon atoms, and R₁, R₂, R₃, and R₄ are independently be an end group selected from H, COOH, COO—, OH, CH₃, tertiary butyl, isopropyl groups.

8. The metallic pigment preparation of claim 1, wherein the passivating agents represented by dimer or trimer fatty acids with >1 carboxylic acid groups have a basic structure (3): 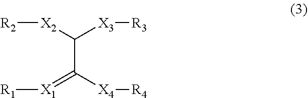
where X₁, X₂, X₃, and X₄ are independently an aliphatic chain of 0-20 sp3 or sp2 hybridized carbon atoms, and R₁, R₂, R₃, and R 4 may independently be an end group from one of the following: H, COOH, COO—, OH, CH₃, tertiary butyl, isopropyl groups. In one embodiment, at least two of the R groups are COOH or COO— groups.

9. The metallic pigment preparation of claim 8, wherein the passivating agents represented by dimer or trimer fatty acids with >1 carboxylic acid groups of the basic structure (3) include non-cyclic isomers of C36 dimers.

10. The metallic pigment preparation of claim 1, wherein the passivating agents are dimer or trimer fatty acids with >1 carboxylic acid groups and have a basic structure (4): 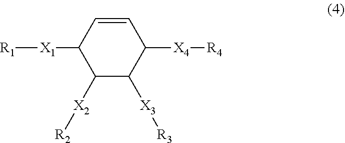
where X₁, X₂, X₃, and X₄ are independently an aliphatic chain of 0-20 sp3 or sp2 hybridized carbon atoms, and R₁, R₂, R₃, and R 4 may independently be an end group from one of the following: H, COOH, COO—, OH, CH₃, tertiary butyl, isopropyl groups.

11. The metallic pigment preparation of claim 10, wherein the passivating agents represented by structure 4 are cis-4-Cyclohexene-1,2-dicarboxylic acid, 5 (or 6)-carboxy-4-hexylcyclohex-2-ene-loctanoic acid, and cyclic isomers of C36 dimers.

12. The metallic pigment preparation of claim 1, wherein the passivating agent is selected from structures 1-4 and combinations thereof.

13. The metallic pigment preparation of claim 1, wherein the metallic pigment is present from 60-95% with respect to the total weight of the preparation.

14. The metallic pigment preparation of claim 1, wherein the metallic pigment is present from 77-95% with respect to the total weight of the preparation.

15. The metallic pigment preparation of claim 1, wherein the metallic pigment is present from 85-99% of a metal and with 1-15% of a milling aid, with respect to the total weight of the preparation.

16. The metallic pigment preparation of claim 1, wherein the metallic pigment preparation is coated with one or more metal oxides selected from silicon oxide, titanium dioxide, zinc oxide, zirconium dioxide, tin oxide, cerium dioxide, vanadium (IV) oxide, manganese oxide, lead oxide, chromium oxide, iron oxide, aluminum oxide, tungsten oxide, and mixtures and alloys.

17. The metallic pigment preparation of claim 1, further comprising additives selected from neutralizing agents, pH adjusters, dispersing additives, anti-foam additives, de-foaming additives, and adhesion promoters.

18. The metallic pigment preparation of claim 18, wherein pH adjusters are amines.

19. A paint, ink, coating or latex composition comprising the metallic pigment preparation of claim 1.

20. A plastic or rubber composition comprising the metallic pigment preparation of claim 1.
